(19) United States
(12) Patent Application Publication
(10) Pub. No.: US 2006/0013007 A1
(43) Pub. Date: Jan. 19, 2006

(54) Lamp and table (lamp 'n' table)

(76) Inventor: Elaine Lopes Passos, Ipanema-Rio de Janeiro (BR)

Correspondence Address: SUGHRUE MION, PLLC, 2100 PENNSYLVANIA AVENUE, N.W., SUITE 800, WASHINGTON, DC, 20037, US

(21) Appl. No.: 10/498,540

(22) PCT Filed: Dec. 5, 2002
(86) PCT No.: PCT/BR02/00173

§ 371 Date: Jul. 18, 2005

(30) Foreign Application Priority Data
Dec. 11, 2001 (BR) MU 8103266-8

(51) Int. Cl. F21V 21/20; F21V 21/38

(52) U.S. Cl. 362/403; 362/401; 362/250; 362/233

(57) ABSTRACT

A lamp and table assembly is provided with a first lamp assembly mounted on a upwardly extending rod connected to the top of the table and a plurality of second light assemblies mounted in a plurality of stools which are intragally connected to the base of the table and a remote control assembly is provided for controlling the hoist assembly.

### BACKGROUND OF THE INVENTION

The present invention is directed to a table construction having unitary stools and a lighting assembly.

### SUMMARY OF THE INVENTION

The lamp and table assembly is a unique accessory for furnishing a home or work environment with style. According to need, it can be a table with or without stools and also supply illumination in a favourite room. The assembly includes a system of speed reducers that guarantee perfect functioning and safety.

The lamp and table can be used at home, in offices, restaurants, bars, recreation areas, discos, clubs, casino, ships etc., in short, anywhere a table is needed the lamp and table that can be hoisted to the ceiling when more space is required, where it can then become a touch of high-tech design lighting.

The lamp and table is attached to a steel cable, incorporating a counterweight and cable take up reel and can be manoeuvred up and down by means of an electronic pulley system with its relative remote control device.

It can be fixed to the ceiling with appropriate fixtures, such as iron or steel rods; it can either hang from the ceiling or be screwed flush to it using the counterweight system (in this case the motor panel will be fixed on the wall) which guarantees safe upwards and downwards, double-hung performance of the lamp and table.

The lamp and table can be supplied with matching stools, which will act as support for the lamp and table when it sits on the floor; or if no stools are required it will come with a base for harnessing it to the floor.

The lamp and table can be manufactured in various materials and shapes (for example: glass, acrylic wood, steel, aluminium, resin; round, square, triangular . . . etc.).

The lamp and table system has at least two different and separate types of illumination: one type is fixed to the ceiling and the other can be manoeuvred up and down with the table itself.

### BRIEF DESCRIPTION OF THE DRAWINGS

The following diagrams and descriptions illustrate this innovative, furnishing accessory wherein:

FIG. 1 is a perspective view of the lamp and table in its lamp version;

FIG. 2 is a section view of the electronic mechanisms of the table;

FIG. 2a is a detail view of the areas A in FIG. 2; and

FIG. 3 illustrates the table in the counterweight version.

### DETAILED DESCRIPTION OF THE INVENTION

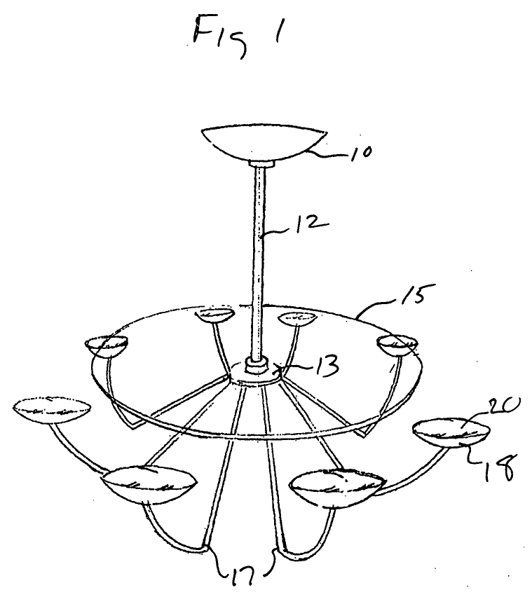

The lamp and table assembly shown in the FIG. 1 is comprised of a table top (15) having a center upwardly extending shaft or cable covering (12) having an illumination assembly (10) at the upper end thereof. The stool legs (17) are connected to the base of the table top by means of a connection joint (16) and a stool (18) is connected to each stool leg. The stool (18) is provided with a cold light bulb (19) for providing illumination which is covered by a stool top (20). An electric cable is provided for supplying electricity to the lamp assembly (10) as well as the cold light bulbs (19).

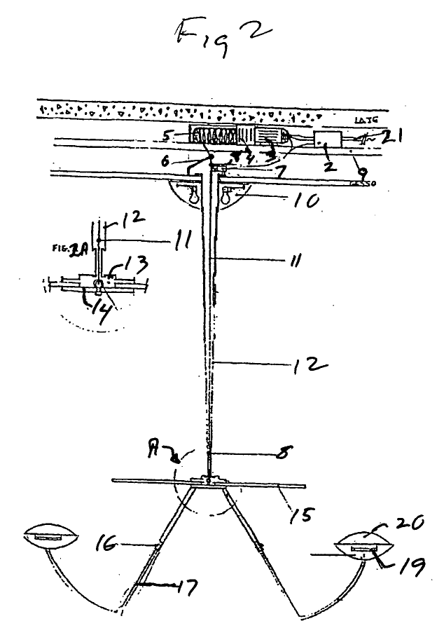

A connector assembly is provided for connecting the support rod (12) to the table top (15) in cooperation with a steel disc (14) as shown in FIG. 2a.

A sectional view of the lamp and table assembly is shown in FIG. 2. The lamp and table assembly of FIG. 1 is in the raised position with the illumination assembly (10) against the ceiling. Above the ceiling a rod (9) is provided for supporting an electric motor (3) which drives a take up reel (5) through a speed reducer mechanism (4). An electric cable (21) supplies power to the motor as well as a micro-switch (7) which controls the operation of the motor (3) in response to a sensor (8) for regulating the height of the lamp and table assembly.

A steel cable (11) is wound on the takeup reel and passes through a steel guide (6) to the hollow support rod (12) where it is connected to the table top supporting member (13). A remote control assembly (2) is connected in the circuit for the electric motor (3) to control the raising and lowering of the lamp and table assembly.

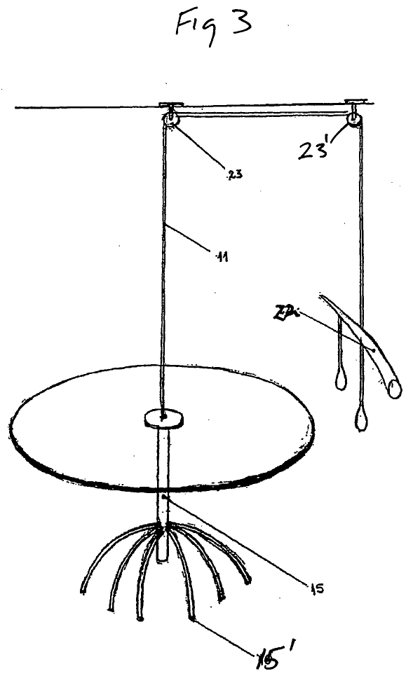

The table assembly shown in FIG. 3 is a variation of the table assembly shown in FIGS. 1 and 2 and is supported by a cable (11) which extends about a pair of pulleys (23, 23′) and the opposite end of the able is connected to a counterweight assembly (22). Thus, the table may be raised an lowered simply by manually raising the table with the assist of the counterweight assembly. Stools could be provided for the assembly but a fixed support assembly (15, 15′) is provided for supporting the table on the floor.

What is claimed is:

1. A lamp and table assembly comprising a table top having a plurality of seats integrally connected thereto, and elongated hollow tube connected to the table top and extending upwardly therefrom, a light assembly secured to the top of the tube, an electrically powered hoist assembly mounted adjacent a ceiling and having a cable extending downwardly therefrom through said tube with a lower end thereof connected to the table.

2. A lamp and table assembly as set forth in claim 1 further comprising additional light assemblies connected to each of the seating assemblies.

3. A lamp and table assembly further comprising a remote control assembly for controlling the hoist means.

4. A table assembly comprising a table top and a base adapted to be mounted on a floor, cable means connected to the table and extending upwardly through pulley means, a counterweight connected to the opposite end of the table to facilitate raising and lowering of the table.
